(19) United States
(12) Patent Application Publication
(10) Pub. No.: US 2004/0255143 A1
(43) Pub. Date: Dec. 16, 2004

(54) Data integrity

(76) Inventors: Kevin Wemyss, Southsea (GB); Anthony Feliks Olech, Droxford (GB)

Correspondence Address: Don W Bulson, Renner Otto Boisselle & Sklar, 19th Floor, 1621 Euclid Avenue, Cleveland, OH, 44115, US

(21) Appl. No.: 10/486,183

(22) PCT Filed: Jun. 19, 2002
(86) PCT No.: PCT/GB02/02861

(30) Foreign Application Priority Data
Aug. 14, 2001 (GB) 0119846.4

(51) Int. Cl. G06F 12/14

(52) U.S. Cl. 713/200; 705/59

(57) ABSTRACT

A method for consuming tokens used to control access to restricted resources held at a user's machine (106) is disclosed. The method comprises: reading a stored token form a first storage area of the user's machine (106), calculating control information for verifying the integrity of the stored token, reading predetermined control information corresponding to the stored token from a second storage area, comparing the control information to the predetermined control information; and consuming the stored token conditional on the control information matching the predetermined control information. The first and second storage areas are separate to help reduce the vulnerability of the tokens to selective replay attack.

### BACKGROUND OF THE INVENTION

The present invention relates to data integrity. In particular it relates to ensuring the integrity of stored data so that any tampering with the stored data is detectable.

Data integrity is important for many applications. It is particularly important where the data is commercially valuable, such as where the data itself has intrinsic value, where the data represents a financial sum or transaction, or where the data acts as a means for enabling access to useful or valuable resources. One example of the latter such case arises where data tokens are used to control access to resources over networks. The tokens may be used to control access to pay-per-access or pay-per-view resources that are conditionally accessible from, for example, the Internet. These tokens are therefore more valuable than a mere collection of data values, in that they also represent monetary value. Thus, the integrity of such tokens is important in preventing fraud and ensuring just revenue for the provider of the resources.

Several schemes exist to reduce the likelihood of fraudulent use of tokens in e-commerce systems such as the pay-per-access or pay-per-view systems previously mentioned. Often tokens are exchanged between vendors and customers when connected over a communications link, such as when a customer connects to a vendor's internet-based web-site. Typically, the exchange of tokens will require the intervention of a third party at some stage of proceedings to confirm that payment will be, or has already been, made for the tokens. However, both direct on-line exchange of tokens between a customer and vendor and on-line verification of tokens involving third party intervention are inconvenient where rapid access to token-consuming resources is required. Such systems are also inconvenient where resources are to be accessed from remote locations where communications links may not be readily available or may only operate at slow data transfer rates:

An example of the inconvenience of prior art systems is perhaps best illustrated by considering the following example situation. Personnel working “in the field”, such as engineers repairing photocopying or computer equipment at client sites, often require access to software applications, such as, for example, diagnostic software tools. Such applications are increasingly licensed for use on a pay-per-use basis. The licence may require the licensee to pay a fee whenever the application is used successfully to complete a job, as indicated by saving a log-file to the engineer's laptop computer hard disk, or following the printing of an invoice or record for the client, for example. The engineer will typically visit many sites in any one day and may use software applications that are traditionally accessed from his local hard disk drive many times per day. This creates a difficulty for the licensor of the software applications when it comes to calculating the fee due for use of those applications.

One solution to this problem of monitoring use of software applications has been to require the engineer to connect his portable machine to a server belonging to the licensor to request access. Typically, the licensor's server verifies the engineer's credentials and either takes an immediate payment or deducts payment from an account which the engineer is authorised to use whilst the engineer's laptop is connected. This scheme has numerous disadvantages which inconvenience the engineer, in particular. Engineers often have to move between numerous client sites and may have to carry additional communications equipment to connect their portable devices, such as laptop computers, to the licensor's server. Additionally, forcing the engineer to access the licensor's server every time access to token-consuming resources is needed is time consuming, repetitive and can be frustrating for the engineer when the infrastructure of the site at which he is working only permits a low-speed access, or worse still has no access, to the licensor's server.

An example of a prior art system that requires on-line verification for permitting access to network resources, in this case pay-per-view world wide web pages, is described in U.S. Pat. No. 5,930,777. In the system described in U.S. Pat. No. 5,930,777 a first party requiring access to a vendor's pay-per-view web pages is directed to a third party, called a banker, that acts as an intermediary between the first party and the vendor. The banker mints tokens and routes the first party to the pay-per-access web pages. The vendor is then credited for the accessed pages without the user learning the network location of the vendor's pay-per-access pages.

Other types of prior art system exist to control access to resources held in data processing systems. For example, it is known to use hardware devices connected to computer systems to ensure that access to software resources is permitted only on a single machine in exchange for appropriate payment. One example of such a system that can be used to control pay-per-access or pay-per-view to resources includes a so called smart card reader that can be used to deduct payments from a securely encrypted card comprising a microprocessor device. Although reasonably secure, such systems are generally recognised as being inconvenient and expensive due to the necessary extra hardware that needs to be added to existing computer systems.

Another way of controlling access to pay-per-use or access systems is to store non-reconciled tokens locally on a computer system that can then consume those tokens as and when necessary. Additional tokens can then be purchased and may be loaded onto the computer system either via a network, or perhaps by a token-provider sending a machine readable medium to the system operator. Such systems rely heavily on the honesty of the user to pay for all the tokens he consumes because it is relatively easy for the user merely to copy existing token record files, use the resources and then selectively re-install the token record files containing credits he has already spent, particularly where the vendor has no way to reconcile the use of the tokens with his records. This method of fraudulently re-installing token record files following previous consumption of the tokens is known as a selective replay attack.

Due to the ease of performing selective replay attacks, the preferred technique for permitting access to pay-per-use resources, particularly resources such as valuable applications such as software used by field engineers, remains to use either an on-line verification technique and/or a hardware device and consequently to tolerate the inherent disadvantages associated with such techniques as described above.

### SUMMARY OF THE INVENTION

According to a first aspect of the present invention there is provided a method for consuming non-reconciled tokens, the method comprising: reading a stored token from a first storage area; calculating control information corresponding to the stored token; reading predetermined control information corresponding to the stored token from a second storage area, wherein the first storage area is separate from the second storage area; comparing the control information to the predetermined control information; and consuming the stored token conditional on the control information matching the predetermined control information. The separation of token data from separate control information prevents opportunist selective replay attacks as both sets of information are needed to consume tokens. Preferably the control information can be hidden from any user and/or at least partially encoded so that it is not immediately evident to the user which information he needs to copy and to where in order to have access to resources.

The resources, for which access is controlled in exchange for consumption of tokens, may be software such as an application program and/or hardware use such as printer, processor, disk drive, memory or communications resources, for example. The resources may be located remotely from any data processing apparatus used to access them, for instance by way of access over a network or by supplying them on removable media, or may be located at the data processing apparatus. The data processing apparatus can be a portable machine for ease of mobility, such as, for example, a laptop computer, a PDA, or a WAP-enabled mobile telephone device, although it may also be any other type of data processing apparatus.

The first and second storage areas can be located on the same type of storage medium or may be found in different media By way of non-limiting example, the storage areas can be located on or in any one or combination of memory, flash memory, hard disk storage space, FDD storage space etc., and they may additionally be located separately on different devices on a network. According to one further aspect of the invention the first and/or second data storage areas can be encrypted to further reduce the likelihood of tampering by users.

According to another aspect of the invention, tokens bought by the user are stored in a token record file. The token record file can be used as a “wrapper” into which further tokens and additional information regarding the tokens themselves, the user, the user's machine, validity information etc. can be added. Information regarding the token record file (such as, for example, user privileges that determine whether a user is to be given credit when buying tokens, how many tokens they are allowed to have, the maximum token value they can use in a particular time etc.) may be stored by a token provider, such as at a token provider's server. In this way it is possible that when a user working for a company wants to download tokens he can be prevented from downloading his entire company's allocation to a single machine and hogging all the tokens to the detriment of his colleagues.

The token record file may be used to keep a record of token usage on a portable machine that may be uploaded at a later time to a token provider's server. This record may be used to determine the amount due for pay-per-use resources at a date sometime after the tokens used to access the pay-per-use resources have been consumed. In this way customers of the token provider may be provided with credit facilities. The record may also indicate that certain tokens have time-expired and/or may be used to record indicators of any suspicious activity that have taken place on the user's machine in order to detect possible fraudulent activity. Consumption of tokens may be permitted conditional on a user connecting to a token provider's server within a predetermined time period. This helps ensure that users contact the token provider regularly, thereby allowing the token provider to supply them with software updates and special offers etc., and to check for any suspicious user activity. To this end, an interval timer may be used at the user's data processing apparatus. The interval timer may be reset every time a user connects to the token provider's server.

According to one further aspect of the invention, the control information corresponding to the stored token is calculated from the token record file using, for example, a message digest. However, any form of encoding, checksumming, hashing and/or encryption algorithm could be used to create the control information provided it gives a reproducible code sequence output when operating on the same input data. The control information may be calculated using only the data in the token record file, or it may also use other information specific to a particular data processing apparatus, such as, for example, a processor serial number and/or a hard disk drive serial number. This can help prevent selective replay attacks and can help ensure that token use can be localised to the particular apparatus for which the tokens are distributed by the token provider.

According to another aspect of the invention at least one security verification file may be stored in the second storage area. The security verification file(s) may be used to contain and/or encode control information relating to stored tokens. The second storage area(s) may be selected from among a plurality of such areas. The security verification file, or files, may store arbitrary data and/or at least part of the control information as content.

According to another aspect of the invention a method for consuming the stored tokens is provided. The method of consuming the tokens may entail modifying the token record file by marking a token contained therein as having been used. A modified token record file containing the token marked as used can then be used to overwrite the previous token record file. New predetermined control information can be calculated from the new token record file written to the second storage area The new control information may be written in one or more security verification files. The previous control information may be deleted. In this way the token record file and associated control information can be automatically updated to reflect changes to either the tokens and/or the additional information stored in the token record file. In a further aspect of the invention, a check is made for the presence of a plurality of token record files and/or security verification files, and all except the most recent can be deleted. This not only ensures “good housekeeping” of the storage areas, but also helps to frustrate selective replay attacks.

According to yet another aspect of the invention data corresponding to at least part of the control information may be hidden using a steganographic hiding technique. Steganographic techniques can be used to help prevent the user being aware that control information exists and/or how it relates to the information contained in the token record file. Any suitable steganographic technique can be used. For example, one or more bits of information corresponding to part, or the whole, of the control information can be hidden by encoding them in file date/time information and/or file path information.

According to an aspect of the invention there is provided a method for storing consumable non-reconciled tokens, the method comprising: receiving a token from a token provider; storing the token in a first storage area; obtaining predetermined control information corresponding to the token; and storing the predetermined control information in a second storage area, wherein the first storage area is separate from the second storage area. The first and second storage areas may be contiguous. The predetermined control information may be determined either by the token provider, or could be calculated by a data processing apparatus located remotely from the token provider. In the former case, the predetermined control information may be downloaded to the user's data processing apparatus. The token provider can be a server, and may provide a service to the user's machine by way of an Internet connection using a world wide web interface. According to another aspect of the invention a check is made for the presence of any token record files and/or security verification files, and if none are found an error may be reported. Any token record files and/or security verification files except the most recent can then be deleted.

Yet another aspect of the invention relates to a method for supplying consumable non-reconciled tokens, the method comprising: generating a unique token; storing a copy of the unique token in at least one data storage device; and providing the unique token to a data processing apparatus to store in a first storage area, and operating the data processing apparatus to store predetermined control information corresponding to the unique token in a second storage area separate from the first storage area. The method may additionally comprise supplying any desired information to the user's data processing apparatus.

In order to manage the token record file according to a further aspect of the invention, a token supplier, or the user's data processing apparatus, may read an expiry time from the token record file (or elsewhere), compare the expiry time to a current system time and refuse to work with the tokens until the expiry time is updated. The expiry time may be calculated as a time interval since a last update. The expiry time may be calculated by way of an interval timer that operates at the user's data processing apparatus. Updating of the expiry time may involve connection to the token provider's server.

According to another aspect of the invention data indicating the number of used tokens and/or unused tokens may be stored at the user's data processing apparatus and/or may be stored on a token provider's server. Tracking the number of tokens and their various statuses allows the token provider the possibility of monitoring a multitude of statistical information (such as a user's rate of token consumption, for example) that can be used to indicate possible fraud and/or provide a tailored service to customers. Events, such as special offers, requests for information etc. may be triggered conditional on the statistical information gathered. For example, triggers may include the numbers of tokens having a particular status being lower than, equal to or higher than various thresholds and/or other triggering criteria, such as rate may be used.

By reading the predetermined control information from the data processing apparatus, reading the unique token from the data processing apparatus, calculating control information from the copy of the unique token, and comparing the predetermined control information to the calculated control information to determine whether there is a match, another aspect of the invention may check for fraudulent activity. If fraudulent activity is detected or suspected, the token provider may refuse to supply further tokens to a particular user, may withdraw credit facilities, may query the user and/or may invalidate existing tokens at the user's data processing apparatus at the earliest opportunity. Many varied actions are possible in response to confirmed user fraud.

According to another aspect of the invention the token provider, or providers, may detect whether resources at the user's data processing apparatus or elsewhere are up-to-date and if not may supply an update, possibly during the same session in which tokens are provided for the user's use.

According to another aspect of the invention, there is provided a system for providing access to resources in exchange for consumption of a token.

According to another aspect of the invention, there is provided a method for the installation and subsequent use of pay-per-use software at a data processing apparatus.

According to another aspect of the invention, there is provided a method for managing a client-side data processing apparatus for acquiring tokens.

According to another aspect of the invention, there is provided a method for managing a server-side data processing apparatus for generating and providing tokens.

According to another aspect of the invention any part, including the whole, of any of the methods described herein is/are implemented as a computer program that configures a data processing apparatus to implement that method or partial method. The computer program(s) may comprise a module or plug-in, or a set of modules or plug-ins, that are operable to configure a web-browser or web-browsers located on one or more data processing apparatus to implement, either individually or together, any aspect of the methods of the present invention.

In a further aspect of the invention, there is provided a carrier medium for the previously described computer program(s). The carrier medium may comprise a magnetic storage medium such as a tape or disc storage medium, an optical storage medium such as a read/write, CD-ROM or solid-state memory. Such storage media may be delivered to a user for loading onto a suitable data processing apparatus. Optionally, the carrier medium may comprise a telecommunications carrier medium, the computer program(s) being embodied as an electronic or electrical signal carried by the telecommunications signal. Such a carrier medium may be an RF carrier signal, or an optical carrier signal for an electronic carrier signal.

In yet another aspect of the present invention, there is provided a data processing apparatus for providing access to resources in exchange for consumption of a consumable non-reconciled token, the data processing apparatus comprising: a controller operable to access at least one data storage device, wherein the at least one data storage device is configured to provide at least a first and a separate second storage area, wherein the first storage area contains data encoding a stored token and the second storage area contains data encoding predetermined control information corresponding to the stored token; and a processor configured to: read the stored token from the first storage area; calculate control information corresponding to the stored token; read predetermined control information corresponding to the stored token from the second storage area; compare the control information to the predetermined control information; and permit access to resources and consume the stored token conditional on the control information matching the predetermined control information. If the token is stored in a token record file in an encrypted form in the first storage area, the token may be decrypted and the token extracted.

According to a further aspect of the invention, there is provided a data processing apparatus for generating and distributing consumable non-reconciled tokens, the data processing apparatus comprising: a communications interface; at least one data storage device; and a processor configured to: generate a unique token; provide a copy of the unique token to the at least one data storage device for staorage; and provide the unique token via the communications interface to a further data processing apparatus for storage in a first storage area, wherein the data processing apparatus stores predetermined control information corresponding to the unique token in a second storage area separate from the first storage area.

According to yet another aspect of the invention, there is provided a method for hiding data, comprising: generating a digital fingerprint from a data file stored in a first storage area; and hiding the digital fingerprint by storing at least part of the digital fingerprint in a second storage area, wherein the first storage area is separate from the second storage area. Optionally, the second storage area may not be directly accessible to a user. The method may comprise generating the digital fingerprint from a message digest generated using the data file. At least part of the digital fingerprint may be hidden using a steganographic technique. The steganographic technique may comprise encoding at least one bit of the digital fingerprint by storing a security verification file at a predetermined file location selected from a plurality of such predetermined file locations. The steganographic technique may comprise encoding at least one bit of the digital fingerprint by modifying a file time stamp of a, or the, security verification file.

### BRIEF DESCRIPTION OF THE DRAWINGS

For a better understanding of the invention and to show how the same may be carried into effect reference is now made by way of example to the accompanying drawings in which:

FIG. 1 shows a system in which a plurality of data processing apparatus for providing access to resources in exchange for consumption of a token according to one aspect of the invention are connected via a network to a data processing apparatus for generating and distributing tokens according to another aspect of the invention.

FIG. 2 is a flowchart showing a method for the initial installation and subsequent use of pay-per-use software at a local machine in accordance with an aspect of the present invention.

FIG. 3 is a flowchart showing a method according to an aspect of the present invention for managing a client-side (user) data processing apparatus for acquiring tokens.

FIG. 4 is a flowchart showing a method for storing tokens according to an aspect of the present invention.

FIG. 5 is a flowchart showing a continuation of the flowchart of FIG. 4.

FIG. 6 is a flowchart showing a method for consuming tokens at a data processing apparatus according to an aspect of the present invention.

FIG. 7 is a flowchart showing a continuation of the flowchart of FIG. 6.

FIG. 8 is a flowchart showing a continuation of the flowchart of FIG. 7.

FIG. 9 is a flowchart showing a method according to an aspect of the present invention for managing a server-side (token provider) data processing apparatus for generating and providing tokens.

FIG. 10 is a flowchart showing a continuation of the flowchart of FIG. 9.

### DETAILED DESCRIPTION

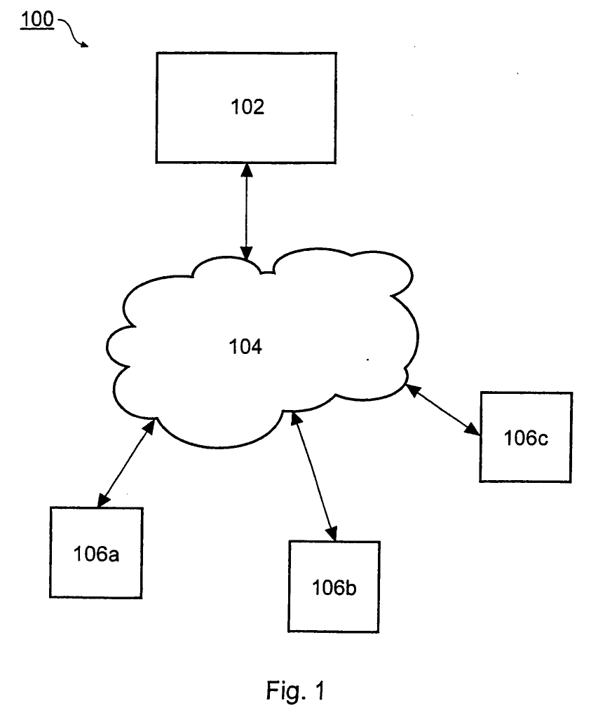

FIG. 1 shows a networked system 100 comprising a token provider server 102 connected to a plurality of workstations 106a-106c via a network 104. The networked system 100 is used to managed the distribution of tokens to the workstations that allow access to resources that are preferably contained within the workstations 106a-106c themselves. Workstation 106a is a portable computer used by a field service engineer that contains application software. The application software is configured to consume a token from the local hard disk drive when the engineer has finished using the application software and update the token record in the token record file. In this way, the application software can be used on a pay-per-use basis with tokens being consumed off-line without needing to be reconciled.

Tokens are downloaded to the workstations 106a-106c from the token provider server 102. Tokens are data objects each of which represents a specific monetary value and each of which is unique. Tokens are produced, or “minted”, using algorithms that incorporate checking information with the token so as to reduce the chance of tokens being forged. The token provider server 102 maintains a database record of all tokens distributed to the workstations 106a-106c, their status and details of the customers to whom the tokens are distributed. The token provider server 102 also manages payment for the tokens by controlling credit and debit payments according to the status of a particular customer. Preferred customers are given credit accounts and can elect to distribute tokens amongst their engineers as they wish. Other customers may be required to make payment for tokens up-front or on a pay-as-you-go basis. Such customer requirements are also recorded by the token provider server 102 which then manages token distribution accordingly.

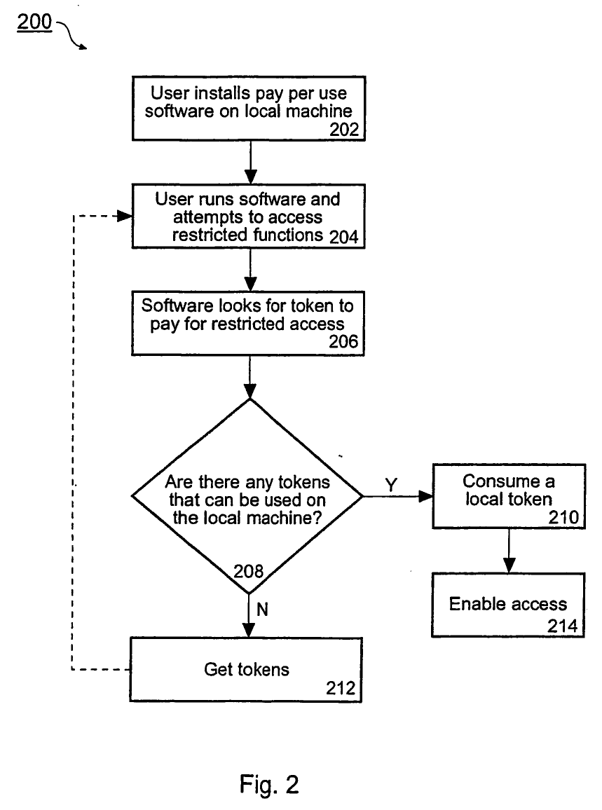

FIG. 2 is a flowchart showing a method for the initial installation and subsequent use of pay-per-use application software stored at workstation 106a. Before the user can begin using the application software, it needs to be installed on the hard disk drive of the workstation 106a. At step 202 the application software is installed by the user using conventional methods such as by using removable program carrying installation media or by downloading the application software from the token provider server 102 via the network 104. Following initial installation, the application software can be upgraded whenever the workstation 106a is in communication with the token provider server 102, should the token provider server 102 determine that such an upgrade is necessary.

After the application software has been installed, the user may attempt to access a function of the software that requires payment in order that the function be operable (step 204). Payment is made by consuming tokens purchased from the token provider. When the engineer attempts to access the restricted functions the application software, at step 206, checks the hard disk to see whether there are any tokens stored thereon that can be used to pay for using the function.

To look for the tokens, the application software checks the hard disk drive for a token record file. The token record file is used as a container to store tokens, associated information and user information securely on the hard disk drive of the workstation 106a, and is stored in an encrypted form to help prevent any user tampering. The encryption (and decryption) scheme uses a symmetric key encryption algorithm taking, for example, the hard disk drive's serial number as its key, so as to help ensure that the encrypted token record file is localised in use to the particular workstation 106a for which the tokens contained in the token record file were sold.

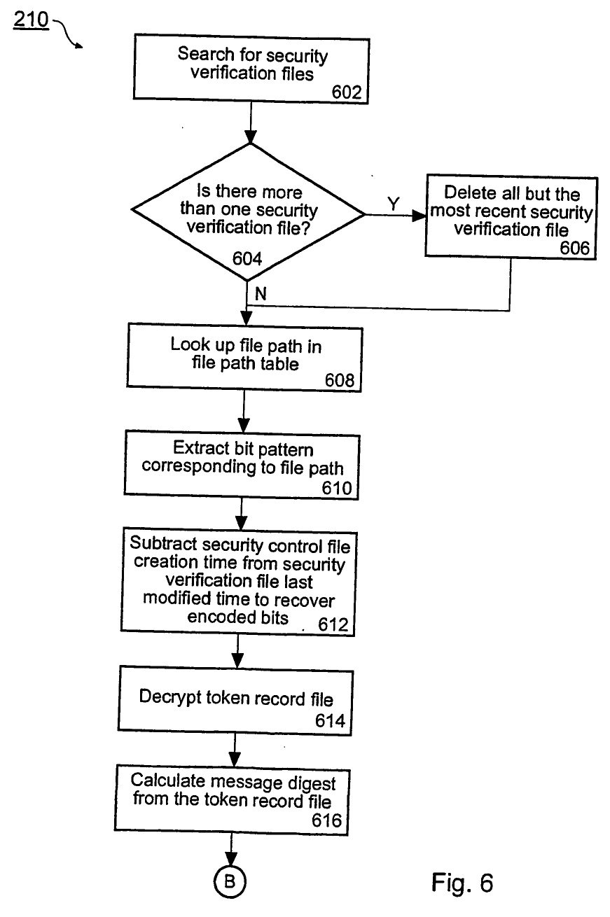

When no unspent tokens are available in a user's record (at step 208), the operation for which tokens are charged will fail to function. To remedy this, the user would have to collect more tokens from the token provider's server (at step 212). If tokens are available, and a chargeable operation is requested, then a token is consumed 210 (see FIGS. 6 to 8 and the following description). Where the process of consuming a local token 210 is successful, the function selected by the user for which payment is required is performed (at step 214). By allowing the consumption of tokens off-line, there is no need to provide for on-line token reconciliation with all its inherent disadvantages. For example, by storing the tokens locally on a user's hard disk drive, they may be rapidly accessed and consumed without awaiting on-line approval for their use.

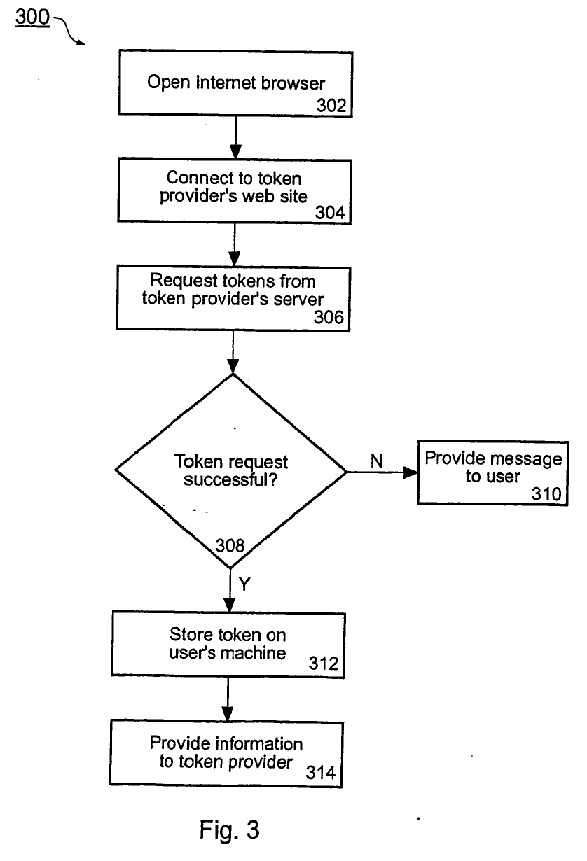

FIG. 3 is a flowchart depicting the method 300 operating client-side (user-side) on the workstation 106a by which tokens are acquired from the token provider server 102. In this embodiment the bulk of the method is invoked using a Java based plug-in, or applet, that runs in the user's web-browser, although here we note that this part of the method may equally well be invoked from within the application software itself. Use of pre-existing web-browser software is preferred in this case as it avoids the need to code communications functionality and protocols into the application software.

At step 302 the application software launches the user's web-browser by calling the web-browser executable with a pointer to the Java applet. The web-browser then launches and when the applet starts it invokes the method illustrated in steps 304 through 314. The web-browser attempts at step 304 to connect to the token provider's web-site, via the internet, which in this case is hosted by the token provider server 102. The user is requested to provide identifying information and a corroborating password. Once a connection is established, a request is made for tokens to be supplied from the token provider server 102 to the workstation 106a (step 306). The request is then dealt with by the token provider server 102 which can release tokens, if available, to the workstation 106a The token provider server 102 also checks the user identity and password.

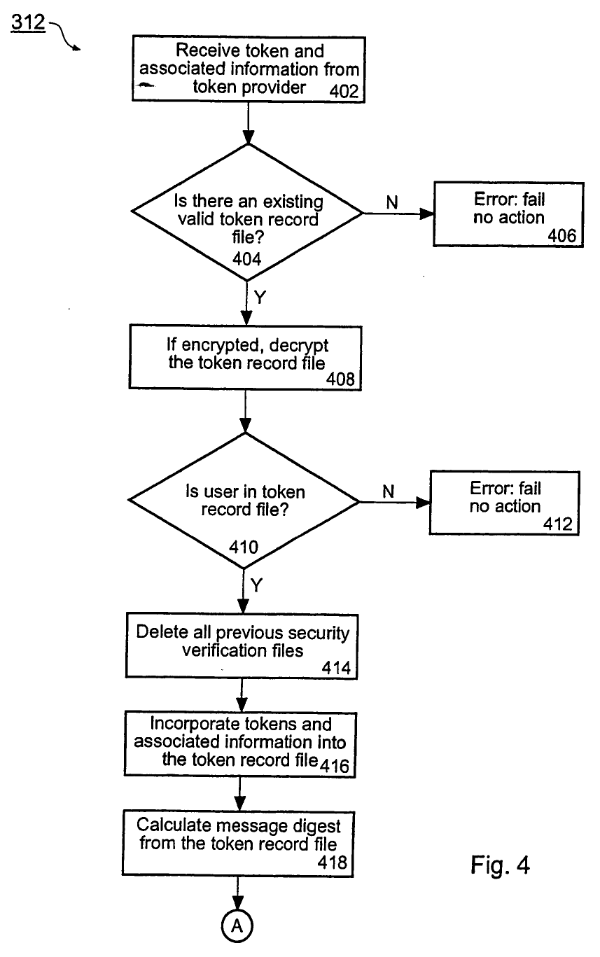

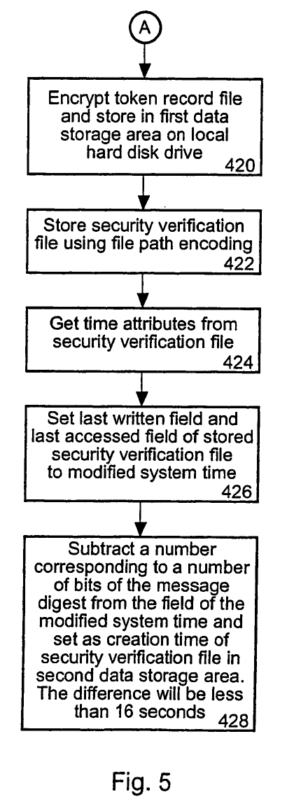

If tokens are not available, or the token request is otherwise unsuccessful, a message is provided to the web-browser from the token provider server 102 indicating reasons for the failure to provide tokens and information on what steps the user should take next (step 310). If the user identification is accepted and the token request is successful, tokens and other information are transmitted to the workstation 106a, over a secure SSL/TLS connection established for the session. At step 312 the applet stores the tokens in an encrypted file on the hard disk drive of the workstation 106a and updates additional control information associated with the token record file to provide further token security (see FIGS. 4 and 5 and the corresponding description below). Information read from an existing token record file on the hard disk during the update process and the workstation 106a is transmitted at step 314 back to the token provider server 102 for analysis and storage. This information includes a count of the number of used and unused tokens, the hard disk serial number as well as the system time at the workstation 106a.

FIG. 4 is a flowchart showing a method for storing tokens 312 on workstation 106a. FIG. 5 is a flowchart showing a continuation of the flowchart of FIG. 4. At step 402 encrypted tokens and time information are received at the workstation 106a The tokens, time information and other information may be transferred from the token provider server and/or the user's data processing apparatus over the secure SSL/TLS connection established for the session. Transfer of data in this fashion uses encryption by virtue of the underlying SSL/TLS protocol, and hence provides token security even if intervening networks are insecure.

Before any tokens are stored on the workstation 106a, the applet performs some housekeeping exercises on the hard disk. Firstly, a check of the hard disk is made at step 404 to determine if there is already a token record file in which the downloaded tokens and any additional information can be stored. At this point, any security verification files associated with the token record file and stored in one of a predetermined set of directories are also noted. If no such security verification file is found stored on the hard disk drive, an error is generated at step 406 that prevents the procedure for storing tokens from continuing. A message may be presented to a user at this point explaining what to do next.

At step 408 a check is performed to test whether the token record file is encrypted. If it is encrypted, the token record file information is decrypted using the hard disk drive serial number as the key. A check is then performed at step 410 to test whether the user is identified in the token record file. If the user is not identified by the token record file, an error is generated (at step 412) and the user is presented with a message explaining that no further tokens will be downloaded. If the user is positively identified, all previous security verification files on the hard disk drive are identified and deleted (step 414).

The tokens to be stored and their respective associated information are then appended to the decrypted pre-existing tokens and token information, at step 416, to form a new data object. The new data object then forms the input to a secure hashing algorithm (in this case SHA-1 is used at step 418) that calculates a 160 bit message digest corresponding to the new data object.

If the original token record file was encrypted, the new data object, corresponding to a new token record file, is encrypted using the hard disk drive serial number as a symmetric key. The token record file, either encrypted or unencrypted, is then stored in a first data storage area on the hard disk drive possibly using file path encoding (step 420).

In order to provide file path encoding, four bits such as for example bit 7 to bit 4 of the 160 bit message digest are used to determine in which directory path a file to which file path encoding is to be applied should be stored in so as to encode the four bits of data. To do this, a set of look-up tables is used. Bits 5 and 4 are used to produce a decimal primary index number from their binary values: i.e. 00=0, 01=1, 10=2 and 11=3. The primary index is used to determine a first partial path of the directory path, thus:

Primary Table

PathA=index 0

PathB=index 1

PathC=index 2

PathD=index 3

Having determined a first partial path, bits 7 and 6 are then used to produce a decimal secondary index number: i.e. 00=0, 01=1, 10=2 and 11=3. Each secondary index is associated with a secondary table. One such table, which is selected for the example where bits 5 and 4 of the message digest are binary 11, is shown as follows:

Secondary Table for index=3

PathD_A=index 0

PathD_B=index 1

PathD_C=index 2

PathD_D=index 3

The secondary index, determined from the primary index, is then used to select a further partial path from the secondary table according to the value of bits 7 and 6. For example, if bits 7 and 6 are set to be binary 10, the secondary index equals two and so the further partial path selected would be PathD_C.

The full directory path, encoding the 4-bits of binary information, in which the file is stored is constructed as a concatenation of the first and the further partial paths as indexed by bits 7 to 4 (when read from MSB to LSB) of the message digest. For example, if bits 7 to 4 are set as “1011”, the file will be stored in directory \PathD\PathD_C.

All combinations of the paths need to be present in order that the file can be stored there. If any path does not exist, it must first be created. The paths selected are those that are ordinarily present on the hard disk drive of the workstation 106a The primary table entries are:

| | |
|---|---|
| c:\ | the windows root directory |
| c:\Program Files | the program files directory |
| c:\windows | the windows system path, could be “winNT” |
| c:\ElanPCCard | Elan eMCE directory |

For the windows root directory the secondary table entries are:

| | |
|---|---|
| <none> | |
| \ElanPCCard | |
| \windows | or “winNT” |
| \Program Files | |

For the program files directory the secondary table entries are:

| | |
|---|---|
| \Accessories | |
| \Common Files\Microsoft Shared\Dao | |
| \System\ole db | or \Common Files\System\ole db |
| \Services | or \Common Files\Services |

For the windows system path directory the secondary table entries are:

| | |
|---|---|
| \system | or \system32 |
| \system\drivers | or \system32\drivers |
| \java | |
| \java\classes | |

For the Elan eMCE (ElanPCCard) directory the secondary table entries are:

\eMCE
\eMCE\CardData
\eMCE\html
\eMCE\document

Having determined the directory in which to store the file using the file path encoding method, the file is then stored.

The file path encoding method as previously described is used to select the location in which a security verification file is stored (step 422). The content of the security verification file consists of a short random string of data stored using a predetermined filename. The path to the security verification file is selected as described previously, and different bits of the message digest can be used to select the file path if both the token record file and the security verification file use file path encodings. For example, bits 11 to 8 of the massage digest may be used, although any combination may be selected. It is even possible to encode using random bits of the message digest, the pattern of which is encrypted as part of the token record file, to provide for further security enhancement.

By way of additional security, a further 4-bits of data corresponding to, for example, bits 3 to 0 (MSB to LSB) of the message digest are steganographically hidden in a second data storage area of the hard disk drive. These 4-bits are encoded by modifying the time stamp data of the stored security verification file that is stored in a second data storage area by the file operating system. The process by which this is achieved is shown by steps 424 to 428.

Firstly, at step 424, the system time of the workstation 106a is read into a first variable following a call to the operating system. The number of seconds is then set to zero. The time stamp of both the last written and last accessed fields are then set to the modified system time value indicated by the variable (step 426). A data value corresponding to the 4-bit number taken from the message digest that is to be encoded is then subtracted as a number of seconds from the variable value. The variable value then indicates a reduced time that is saved as the new creation time of the security verification file (step 428). In this way, data is hidden on the disk in the data area reserved for recording file attributes.

At the end of the process of FIG. 5, a security verification file is to be found stored on the hard disk drive of the workstation 106a along with other hidden control information that is used to verify the integrity of tokens and other data stored in the token record file.

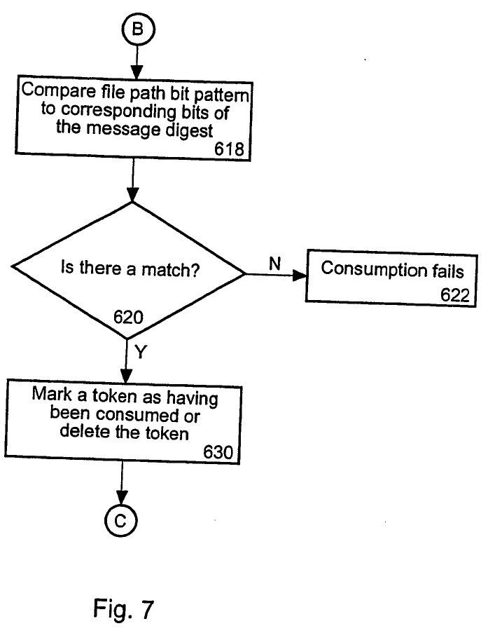

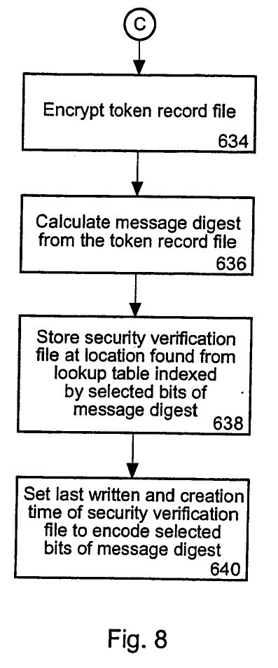

FIG. 6 is a flowchart showing a method for consuming tokens 210 at a workstation 106. FIGS. 7 and 8 are flowcharts showing a continuation of the flowchart that starts at FIG. 6. This process is carried out by the application software that is stored at the workstations.

The process of consuming a token 210 begins, at step 602, with the application software searching the predetermined set of file location paths (see above) in which security verification files may be stored. A search is made to determine whether or not more than one security verification file exists (step 604). If more than one security verification file exists, then all but the most recent is deleted (step 606). A process of recovering the 8-bits of the message digest encoded by the security verification file then begins (steps 608 to 612). This works substantially by reversing each of the two processes used to encode the two sets of 4-bits in the first place. Optionally, an additional verification check is also made if the token record file also encodes part of the message digest.

The file location of the security verification file is determined during the search for the security verification file and accounting for any subsequent deletions. The bit pattern corresponding to four bits of the message digest used to determine the security verification file location are found by comparing the storage path to a set of tables and looking up the corresponding bit values (steps 608 and 610). Next, in step 612, the information corresponding to the four bits of the message digest used to determine the security verification file location are found from the file attribute information by subtracting the security verification file creation time from the security verification file written time.

The token record file is then decrypted in step 614 using the hard disk drive serial number as a symmetric key. The decrypted token record file data is then used as input to the same secure hashing algorithm that is used when the tokens are being stored to produce a message digest (step 616). Thereafter, the recovered steganographic bit pattern is compared to the respective bits of message digest (step 618). Any mismatch between these sets of data causes the consumption process to fail, during which process (step 622) a message is issued to the user and a record of failure is written to the hard disk drive.

Where the token record file has been validated, the application software searches the decrypted token record file for a token that has associated information indicating that it is valid (step 630). The token is then either marked as having been used, or deleted to free up space in the token record file for new tokens that will be loaded at a later time. Having consumed a token, the token record file is re-encrypted and new control information calculated and used to store the encrypted token record file (steps 634 to 640), in much the same manner as is used to store new tokens as described above. Having consumed a token the application software then grants the user access to the protected resources.

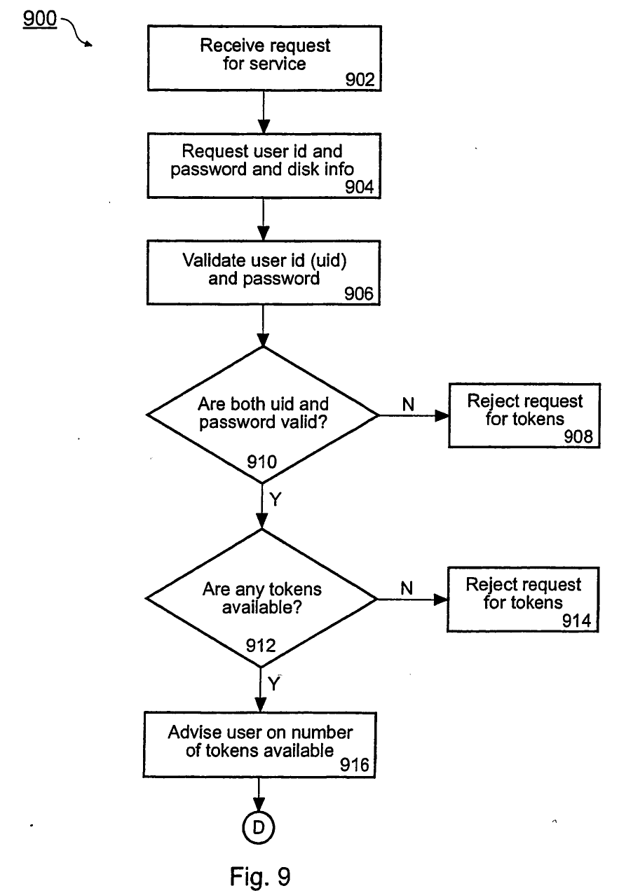

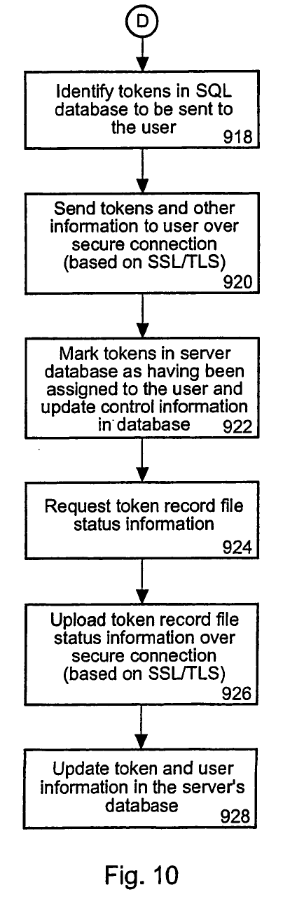

FIG. 9 is a flowchart showing a method 900 that is used at the token provider server 102 for generating and providing tokens. FIG. 10 is a flowchart showing a continuation of the flowchart of FIG. 9. The method is implemented as a software module or object running in conjunction with, or as part of, a stand-alone executable program to deal with individual requests for tokens.

The token provider server 102 is connected to a firewall web-server (not shown) that continuously monitors a communications link for external requests for information, tokens etc. The firewall server is operable to forward requests for service from external users to the token provider server 102 and to provide data from the token provider server 102 to the external users. Requests for tokens are passed from the firewall web-server to the token provider server 102. Additionally, the function of the firewall web-server is to provide standard information over an internet link to requesting parties, and to secure the token provider server 102 from external interference.

At step 902, the token provider server 102 receives a request for provision of tokens indirectly from an external user. The token provider server 102 then sends a request to the external user for his user identification (uid), password and the user's hard disk drive serial number (step 904). If a user identification and password are received in response to this request, a check is made in a database of user id's and passwords to see whether there is an entry for the provided uid and if so whether it corresponds to the password provided (steps 906 and 910). If there is no match in the database for the uid, or if the password does not match the uid, the token provider server 102 sends a message to the external user to say that the request to provide tokens has failed, and provides the reasons for the failure (step 908).

When an existing user is positively identified, a check is made at step 912 to see whether there are any tokens available to the user. Tokens may be made available on credit for certain users (such as corporate users) or may have been paid for in advance via an online connection, over the telephone by credit/debit card, by post with a cheque etc. Advance payment for tokens is preferably performed separately from their provision to the user. The tokens, which are themselves sequentially chosen numbers, are then held in an SQL token database to which the token provider server 102 has access, and distributed to the users as necessary. If there are no tokens available to the user, the request for tokens is rejected at step 914. A rejection at this stage is accompanied by a message informing the user that tokens are unavailable, the reasons for this and what the user might do to remedy the situation.

Where tokens are available to the user, the user is informed at step 916 of the number of tokens at their disposal and prompted to request the number that are required to be downloaded to the user's machine. The user's request is sent to the token provider server 102 which then identifies the requested number of tokens in the SQL database to be sent to the user (step 918). At step 920 a secure session based upon SSL/TLS is setup between the token provider server 102 and the user's data processing apparatus 106. Tokens and other information, such as the time interval after which the tokens expire, is communicated to the user's data processing apparatus 106 by way of the secure session. Thereafter, the tokens and other information are processed at the user's data processing apparatus 106 according to the method 312 described above and illustrated in FIG. 4 below.

Once the tokens have successfully been sent to the user, the tokens are marked in the SQL database as having been assigned to the user, and control information regarding the tokens is updated (step 922). As an additional check, the token provider server 102 sends a request to the user identified using an internal database record to request confirmation that the sent tokens have been received and stored without error. Any errors can be dealt with according to their nature, and the details of the error handling procedures are not deemed to require further explanation here. In addition to providing the token provider server 102 with a confirmation of a successful token transfer, a request for information regarding the status of the token record file held at the user's machine is requested (step 924). This status information could include the number of failed attempts there have been to consume tokens, the nature of any failures (time-expiry or possible fraudulent use) and an indication of the local time set on the system clock of the user's machine. At step 926, the status information is uploaded to the token provider server 102 over the secure SSL/TLS session. This information is then stored at step 928 in the token database where it may subsequently be analysed to check for any suspicious user activity. At step 928 the user information is also updated, in particular a record of the number of tokens available to the user is decreased by the number of tokens that have just been successfully provided to the user's data processing apparatus 106.

Alternative embodiments of the invention generate keys for encrypting and decrypting token record files by combining a hard drive serial number with a random number to create a unique installation number. The unique installation number is stored in the token record file on the user's machine and on the token provider server during the signup process. The unique installation number is also used to identify the user in future communications.

Although the invention has been described in relation to the preceding example embodiments, it will be readily understood by those of ordinary skill in the art that many different embodiments employing the inventive concepts of the invention are possible. For example, although security verification files have been described in conjunction with the encoding of the eight least significant bits of a message digest, it is understood that any number of bits may be encoded using the techniques described. Furthermore, the bits selected for encoding may be selected, either individually or in any combination, from any bit position of a message digest and/or other such control information. Moreover, those skilled in the art will understand that the token record files themselves could also be used to encode control information and that any number of security verification files may be used to increase the number of bits of information hidden. It is the applicant's intention that all such variants fall within the scope of the invention.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

1. A method for consuming non-reconciled tokens, said method comprising:
reading a stored token from a first storage area;
calculating control information corresponding to said stored token;
reading predetermined control information corresponding to said stored token from a second storage area, wherein said first storage area is separate from said second storage area;
comparing said control information to said predetermined control information; and
consuming said stored token conditional on said control information matching said predetermined control information.

2. The method of claim 1, wherein said stored token is stored in a token record file.

3. The method of claim 2, wherein said token record file further comprises information indicating an expiry time of said stored token.

4. The method of claim 1, wherein consumption of said stored token is further conditional upon a time interval between a last recorded update time and a current time not exceeding a predetermined value.

5. The method of claim 2, wherein said token record file further comprises user information corresponding to said stored token.

6. The method of claim 2, wherein said token record file further comprises information indicating whether said stored token is valid.

7. The method of claim 2, wherein at least one further token is stored in said token record file.

8. The method of claim 7, wherein said token record file further comprises information indicating an expiry time of each of said at least one further token.

9. The method of claim 7, wherein said token record file further comprises user information corresponding to each of said at least one further token.

10. The method of claim 7, wherein said token record file further comprises information indicating whether each of said at least one further token is valid or not.

11. The method of claim 2, wherein said token record file is stored in an encrypted form in said first storage area.

12. The method of claim 2, wherein said step of calculating control information corresponding to said stored token comprises calculating a message digest from said token record file.

13. The method of claim 2, wherein said step of consuming said stored token comprises:
modifying said token record file by marking said stored token as having been used;
storing said modified token record file in place of said token record file in said first storage area;
calculating new predetermined control information from said modified token record file; and
storing said new predetermined control information in place of said control information in said second storage area.

14. The method of claim 1, comprising storing a security verification file in said second storage area.

15. The method of claim 14, further comprising:
checking said second storage area for the presence of a plurality of security verification files; and
deleting all security verification files except the most recent security verification file.

16. The method of claim 1, wherein said first and second storage areas are located in a single data storage device.

17. The method of claim 1, wherein data stored in said second storage area is hidden using a steganographic hiding technique.

18. The method of claim 1, further comprising the step of enabling access to restricted access resources conditional on consumption of said stored token.

19. The method of claim 1, further comprising the step of enabling access to pay-per-access resources conditional on consumption of said stored token.

20. A method for storing consumable non-reconciled tokens, said method comprising:
receiving a token from a token provider;
storing said token in a first storage area;
obtaining predetermined control information corresponding to said token; and
storing said predetermined control information in a second storage area, wherein said first storage area is separate from said second storage area.

21. The method of claim 20, wherein the step of storing said token in a first storage area comprises storing said token in a token record file.

22. The method of claim 20 or claim 21, comprising storing a security verification file in said second storage area.

23. The method of claim 20, further comprising storing information indicating a time of last access to said token provider.

24. The method of claim 21, further comprising storing user information corresponding to said token in said token record file.

25. The method of claim 21, further comprising storing information indicating whether said stored token is valid in said token record file.

26. The method of claim 21, wherein at least one further token is stored in said token record file.

27. The method of claim 21, wherein said token record file is stored in an encrypted form in said first storage area.

28. The method of claim 21, wherein said step of obtaining predetermined control information corresponding to said token comprises calculating said predetermined control information from said token record file.

29. The method of claim 28, wherein said step of calculating said predetermined control information from said token record file comprises calculating a message digest from said token record file.

30. The method of claim 20, wherein said step of obtaining predetermined control information corresponding to said token comprises downloading said predetermined control information from said token provider.

31. The method of claim 20, wherein said token provider is a server.

32. The method of claim 20, further comprising:
checking said first storage area for the presence of a token record file and/or a security verification file(s); and
informing a user conditional on the token record file and/or security verification file(s), being absent that the user needs to register online before proceeding.

33. The method of claim 21, wherein said step of storing said token further comprises:
modifying said token record file to incorporate said token; and
storing said modified token record file in place of said token record file in said first storage area.

34. The method of claim 20, wherein said first and second storage areas are located in a single data storage device.

35. The method of claim 20, wherein data stored in said second storage area is hidden using a steganographic hiding technique.

36. A method for supplying consumable non-reconciled tokens, said method comprising:
generating a unique token;
storing a copy of said unique token in at least one data storage device;
providing said unique token to a data processing apparatus to store in a first storage area; and
operating said data processing apparatus to store predetermined control information corresponding to said unique token in a second storage area separate from said first storage area.

37. The method of claim 36, wherein said unique token is stored in a token record file in said first storage area.

38. The method of claim 36, further comprising providing information indicating an expiry time of said unique token to said data processing apparatus.

39. The method of claim 38, further comprising storing a copy of said information indicating an expiry time of said unique token in said at least one data storage device.

40. The method of claim 38, wherein said information indicating an expiry time of said unique token is a time interval.

41. The method of claim 36, wherein said unique token is generated using user information.

42. The method of claim 36, further comprising providing information indicating that said unique token is valid to said data processing apparatus.

43. The method of claim 36, further comprising reading a number indicating how many consumed tokens reside on said data processing apparatus from said data processing apparatus.

44. The method of claim 43, further comprising blocking the provision of further tokens to said data processing apparatus conditional on said number of consumed tokens residing on said data processing apparatus not exceeding a first predetermined value.

45. The method of claim 36, further comprising reading a number indicating how many unused tokens reside on said data processing apparatus from said data processing apparatus.

46. The method of claim 45, further comprising blocking the provision of further tokens to said data processing apparatus conditional on said number of unused tokens residing on said data processing apparatus equalling or exceeding a second predetermined value.

47. The method of claim 36, wherein a security verification file is stored in said second data storage area.

48. The method of claim 36, comprising:
reading said predetermined control information from said data processing apparatus;
reading said unique token from said data processing apparatus;
calculating control information from said copy of said unique token; and comparing said predetermined control information to said calculated control information to determine whether there is a match, wherein an inexact match indicates fraudulent activity.

49. The method of claim 48, further comprising blocking the provision of further tokens to said data processing apparatus conditional on said predetermined control information not being an exact match to said calculated control information.

50. The method of claim 37, comprising:
reading said predetermined control information from said data processing apparatus:
calculating control information from said copy of said unique token; and
comparing said predetermined control information to said calculated control information to determine whether there is a match, wherein an inexact match indicates fraudulent activity, wherein said step of calculating control information corresponding to said unique token comprises calculating a message digest from said token record file.

51. The method of claim 37, wherein said token record file is stored in an encrypted form in said first storage area.

52. The method of claim 36, wherein said first and second storage areas are located in a single data storage device.

53. The method of claim 36, wherein data stored in said second storage area is hidden using a steganographic hiding technique.

54. The method of claim 36, wherein said step of providing said unique token to said data processing apparatus further comprises taking prepayment in exchange for said unique token.

55. The method of claim 36, wherein said step of providing said unique token to said data processing apparatus further comprises charging a sum to a pre-existing customer credit account in exchange for said unique token.

56. The method of claim 36, further comprising downloading a software update to said data processing apparatus.

57. A computer program operable to configure a data processing apparatus to implement a method for consuming non-reconciled tokens said method comprising:
reading a stored token from a first storage area;
calculating control information corresponding to said stored token;
reading predetermined control information corresponding to said stored token from a second storage area wherein said first storage area is separate from said second storage area;
comparing said control information to said predetermined control information; and
consuming said stored token conditional on said control information matching said predetermined control information.

58. A computer carrier medium carrying a computer program according to claim 57.

59. A data processing apparatus for providing access to resources in exchange for consumption of a consumable non-reconciled token, said data processing apparatus comprising:
a controller operable to access at least one data storage device, wherein said at least one data storage device is configured to provide at least a first and a separate second storage area, wherein said first storage area contains data encoding a stored token and said second storage area contains data encoding predetermined control information corresponding to said stored token; and
a processor configured to:
a) read said stored token from said first storage area;
b) calculate control information corresponding to said stored token;
c) read predetermined control information corresponding to said stored token from said second storage area;
d) compare said control information to said predetermined control information; and
e) permit access to resources and consume said stored token conditional on said control information matching said predetermined control information.

60. The data processing apparatus of claim 59, wherein said stored token is stored in a token record file.

61. The data processing apparatus of claim 60, wherein said token record file further comprises information indicating an expiry time of said stored token.

62. The data processing apparatus of claim 59, wherein consumption of said stored token is further conditional upon a time interval between a last recorded update time and a current time not exceeding a predetermined value.

63. The data processing apparatus of claim 60, wherein said token record file further comprises user information corresponding to said stored token.

64. The data processing apparatus of claim 60, wherein said token record file further comprises information indicating whether said stored token is valid.

65. The data processing apparatus of claim 60, wherein at least one further token is stored in said token record file.

66. The data processing apparatus of claim 65, wherein said token record file further comprises information indicating an expiry time of each of said at least one further token.

67. The data processing apparatus of claim 65, wherein said token record file further comprises user information corresponding to each of said at least one further token.

68. The data processing apparatus of claim 65, wherein said token record file further comprises information indicating whether each of said at least one further token is valid or not.

69. The data processing apparatus of claim 60, wherein said token record file is stored in an encrypted form in said first storage area and said step of reading said stored token from said first storage area comprises decrypting said encrypted token record file and extracting said stored token.

70. The data processing apparatus of claim 60, wherein said processor is configured to calculate control information corresponding to said stored token by calculating a message digest from said token record file.

71. The data processing apparatus of claim 60, wherein said processor is configured to consume said stored token by:
modifying said token record file by marking said stored token as having been used;
storing said modified token record file in place of said token record file in said first storage area;
calculating new predetermined control information from said modified token record file; and
storing said new predetermined control information in place of said control information in said second storage area.

72. The data processing apparatus of claim 59, wherein said processor is configured to store a security verification file in said second storage area.

73. The data processing apparatus of claim 72, wherein said processor is further configured to:
check said second storage area for the presence of a plurality of security verification files; and
delete all security verification files except the most recent security verification file.

74. The data processing apparatus of claim 59, wherein said first and second storage areas are located in a single data storage device.

75. The data processing apparatus of claim 59, wherein data stored in said second storage area is hidden using a steganographic hiding technique.

76. The data processing apparatus of claim 59, wherein said resources comprise a software application.

77. The data processing apparatus of claim 76, wherein said processor is configured to consume said stored token when data is saved from said software application.

78. A data processing apparatus for generating and distributing consumable non-reconciled tokens, said data processing apparatus comprising:
a communications interface;
at least one data storage device; and
a processor configured to:
a) generate a unique token;
b) provide a copy of said unique token to said at least one data storage device for storage; and
c) provide said unique token via said communications interface to a further data processing apparatus to store in a first storage area, wherein said data processing apparatus stores predetermined control information corresponding to said unique token in a second storage area separate from said first storage area.

79. The data processing apparatus of claim 78, wherein said further data processing apparatus is operable to store said unique token in a token record file in said first storage area.

80. The data processing apparatus of claim 78, wherein said processor is further configured to provide time information to said further data processing apparatus.

81. The data processing apparatus of claim 80, wherein said time information is a time interval after which tokens are unusable.

82. The data processing apparatus of claim 80, wherein said processor is further configured to store a copy of time information in said at least one data storage device.

83. The data processing apparatus of claim 78, wherein said processor is configured to generate said unique token using user information.

84. The data processing apparatus of claim 78, wherein said processor is configured to provide information to said further data processing apparatus indicating that said unique token is valid.

85. The data processing apparatus of claim 78, wherein said processor is configured to read from said further data processing apparatus a number indicating how many consumed tokens reside on said further data processing apparatus.

86. The data processing apparatus of claim 85, wherein said processor is configured to block the provision of further tokens to said further data processing apparatus conditional on said number of consumed tokens not exceeding a first predetermined value.

87. The data processing apparatus of claim 78, wherein said processor is configured to read from said further data processing apparatus a number indicating how many unused tokens reside on said further data processing apparatus.

88. The data processing apparatus of claim 87, wherein said processor is configured to block the provision of further tokens to said further data processing apparatus conditional on said number of unused tokens equalling or exceeding a second predetermined value.

89. The data processing apparatus of claim 78, wherein a security verification file is stored in said second data storage area.

90. The data processing apparatus of claim 78, wherein said processor is further configured to:
read said predetermined control information from said further data processing apparatus;
read said unique token from said further data processing apparatus;
calculate control information from said copy of said unique token; and
compare said predetermined control information to said calculated control information to determine whether there is a match, an inexact match being indicative of possible fraudulent activity.

91. The data processing apparatus of claim 90, wherein said processor is configured to block the provision of further tokens to said further data processing apparatus conditional on said predetermined control information not being an exact match to said calculated control information.

92. The data processing apparatus of claim 90, wherein said further data processing apparatus is operable to store said unique token in a token record file in said first storage area, and wherein said processor is configured to calculate said control information by calculating a message digest from said token record file.

93. The data processing apparatus of claim 78, wherein said processor is operable to encrypt said unique token before providing an encrypted version of said unique token via said communications interface.

94. The data processing apparatus of claim 78, wherein said first and second storage areas of said further data processing apparatus are located in a single data storage device.

95. The data processing apparatus of claim 78, wherein data stored in said second storage area of said further data processing apparatus is hidden using a steganographic hiding technique.

96. The data processing apparatus of claim 78, wherein said processor is configured to provide said unique token to said further data processing apparatus in exchange for a prepayment.

97. The data processing apparatus of claim 78, wherein said processor is configured to provide said unique token to said further data processing apparatus following addition of a charge to a pre-existing customer credit account.

98. The data processing apparatus of claim 78, wherein said processor is configured to supply a software update to said further data processing apparatus.

99. A method for hiding data, comprising:
generating a digital fingerprint from a data file stored in a first storage area; and
hiding said digital fingerprint by storing at least part of said digital fingerprint in a second storage area, wherein said first storage area is separate from said second storage area.

100. The method of claim 99, wherein said second storage area is not directly user-accessible.

101. The method of claim 99, wherein said digital fingerprint is a message digest generated from at least said data file.

102. The method of claim 99, wherein said at least part of said digital fingerprint is hidden using a steganographic technique.

103. The method of claim 102, wherein said steganographic technique comprises encoding at least one bit of said digital fingerprint by storing a security verification file at one location selected from a plurality of predetermined file locations.

104. The method of claim 103, wherein said steganographic technique comprises encoding at least one further bit of said digital fingerprint by modifying a file time stamp of said security verification file.

105. The method of claim 102, wherein said steganographic technique comprises encoding at least one bit of said digital fingerprint by modifying a file time stamp of a security verification file.

106. A computer program operable to configure a data processing apparatus to implement a method for storing consumable non-reconciled tokens, said method comprising:
receiving a token from a token provider;
storing said token in a first storage area;
obtaining predetermined control information corresponding to said token; and
storing said predetermined control information in a second storage area, wherein said first storage area is separate from said second storage area.

107. A computer carrier medium carrying a computer program according to claim 106.

108. A computer program operable to configure a data processing apparatus to implement a method for storing consumable non-reconciled tokens, said method comprising:
generating a unique token;
storing a copy of said unique token in at least one data storage device;
providing said unique token to a data processing apparatus to store in a first storage area; and
operating said data processing apparatus to store predetermined control information corresponding to said unique token in a second storage area separate from said first storage area.

109. A computer carrier medium carrying a computer program according to claim 108.
